(19) United States
(12) Patent Application Publication
(10) Pub. No.: US 2021/0252352 A1
(43) Pub. Date: Aug. 19, 2021

(54) SHAFTS WITH REINFORCING LAYER FOR SPORTING GOODS AND METHODS OF MANUFACTURE

(71) Applicant: Aldila Golf Corporation, Carlsbad, CA (US)

(72) Inventors: Stephen Greenwood, Brea, CA (US); Tod Boretto, Poway, CA (US)

(21) Appl. No.: 17/165,721

(22) Filed: Feb. 2, 2021

Related U.S. Application Data
(63) Continuation-in-part of application No. 15/639,654, filed on Jun. 30, 2017, now Pat. No. 10,907,942.
(60) Provisional application No. 63/086,017, filed on Sep. 30, 2020.
(60) Provisional application No. 62/374,508, filed on Aug. 12, 2016.
(60) Provisional application No. 62/357,778, filed on Jul. 1, 2016.

(51) Int. Cl. A63B 53/10; B29C 70/22; B29C 70/86; B29C 53/60

(52) U.S. Cl. CPC A63B 53/10; B29C 70/224; A63B 2102/32; B29C 53/602; B29C 70/86

(57) ABSTRACT

Disclosed herein are composite shafts for sporting goods, such as archery arrows, golf clubs, and rifles, which include a reinforcing layer to improve the performance of the sporting goods.

### CROSS-REFERENCE TO RELATED APPLICATIONS

This application claims the benefit of U.S. Provisional Application No. 63/086,017 filed Sep. 30, 2020, which is incorporated by reference herein in its entirety. This application is a continuation-in-part of U.S. application Ser. No. 15/639,654 filed Jun. 30, 2017 and issued Feb. 2, 2021 as U.S. Pat. No. 10,907,942, which claims the benefit of U.S. Provisional Application No. 62/357,778 filed Jul. 1, 2016 and U.S. Provisional Application No. 62/374,508 filed Aug. 12, 2016, each of which is incorporated by reference herein in its entirety.

### BACKGROUND

Traditionally, shafts for arrows and other sporting goods were made from wood, bamboo, and/or reeds. To decrease their weight and produce, for example, arrows that are easier to shoot and that can fly farther, and golf clubs that are easier to swing, modern arrows, golf clubs, and other sporting goods are made from aluminum and carbon fiber reinforced plastic. Carbon fiber, a type of fiber reinforced plastic, has been used since the 1990s as a lightweight material used to make arrows and other sporting goods. While modern materials are lighter in weight than traditional materials, modern materials are not as durable.

### SUMMARY

Various embodiments of the present invention provide improved shafts that can be used in a number of different applications, for example, for various sporting goods, such as, but not limited to, archery arrows, arrow shafts, crossbow bolts, archery bow stabilizers, golf shafts, golf clubs, and rifle barrels. In particular, embodiments of the present invention relate to adding a reinforcing layer to improve the performance of sporting goods shafts.

In some embodiments, the invention provides a hollow golf club shaft, comprising: a plurality of fiber-reinforced resin layers; and one or more reinforcing layers comprising a woven metal mesh, each reinforcing layer spanning a circumference of the golf club shaft, wherein the woven metal mesh comprises stainless steel, nickel, titanium, copper, aluminum, magnesium, or an alloy thereof, and wherein the woven metal mesh has at least 150×150 wires per square inch.

In some embodiments, the invention provides a method of manufacturing a reinforced shaft for a golf club, comprising: wrapping a plurality of fiber-reinforced resin layers around a mandrel; and wrapping one or more reinforcing layers around at least one of the plurality of fiber-reinforced resin layers, wherein the reinforcing layer(s) comprise a woven metal mesh and span a circumference of the golf club shaft, wherein the woven metal mesh comprises stainless steel, nickel, titanium, copper, aluminum, magnesium, or an alloy thereof, and wherein the woven metal mesh has at least 150×150 wires per square inch.

In some embodiments, the reinforcing layer(s) are located in the butt section of the golf club shaft, the mid section of the golf club shaft, or the tip section of the golf club shaft.

In some embodiments, the reinforcing layer(s) extend along the full length of the golf shaft.

In some embodiments, the woven metal mesh is positioned on the golf club shaft at a zero- and ninety-degree wire orientation, where the zero-degree wires are in line with a longitudinal axis of the golf shaft, and the ninety-degree wires are oriented perpendicular thereto.

In some embodiments, the woven metal mesh comprises wire having a diameter of about 0.001 inches to about 0.008 inches.

In some embodiments, the woven metal mesh comprises wire having a diameter less than or equal to 0.001 inches.

In some embodiments, the woven metal mesh has a plain weave, Dutch weave, twilled weave, twilled Dutch weave, reverse Dutch weave, or five heddle weave.

In some embodiments, the woven metal mesh is impregnated with a resin.

In some embodiments, the woven metal mesh is annealed.

In some embodiments, at least one of the plurality of fiber-reinforced resin layers comprises a carbon fiber.

Additional features and advantages of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of certain embodiments of the application, will be better understood when read in conjunction with the appended drawings. For the purposes of illustrating the devices and methods of the present application, there are shown in the drawings preferred embodiments. It should be understood, however, that the application is not limited to the precise arrangements and instrumentalities shown. In the drawings:

FIG. 1 is a perspective view of a reinforced shaft according to some embodiments of the invention;

FIG. 2 is cross-section view of the reinforced shaft of FIG. 1, taken along line 2-2;

FIG. 3 is a perspective view of a carbon fiber blank, according to some embodiments;

FIG. 4 is a perspective view of a reinforcing layer, according to some embodiments;

FIG. 5 is a close-up view of a reinforcing layer according to some embodiments, showing the weave pattern of the reinforcing layer;

FIG. 5A is a close-up view of two reinforcing layers according to some embodiments, showing the weave pattern of the reinforcing layers;

FIG. 6 is a side view of a mandrel with carbon fiber material wrapped around the mandrel, according to some embodiments;

FIG. 7 is a side view of the mandrel with carbon fiber material wrapped around the mandrel being wrapped with a reinforcing layer, according to some embodiments;

FIG. 8 is a side view of the mandrel with the reinforcing layer wrapped around the carbon fiber material wrapped around the mandrel, according to some embodiments;

FIG. 9 is a side view of the reinforced shaft being removed from the mandrel;

FIG. 10A shows top, side, and end views of a standard weave mesh, according to some embodiments;

FIG. 10B is a perspective view of a standard weave mesh, according to some embodiments;

FIG. 11 is a schematic of a pre-impregnation process, according to some embodiments;

FIG. 12 is a side view of a reinforced shaft according to some embodiments of the invention;

FIG. 13 is a cross section view of a reinforced shaft according to some embodiments of the invention;

FIG. 14 is a cross section view of a reinforced shaft according to some embodiments of the invention;

FIG. 15 is a schematic of a reinforcing layer according to some embodiments of the invention, showing an illustrative single wrap and double wrap;

FIG. 16 is a perspective view of a reinforced shaft for a golf club, according to some embodiments of the invention;

FIG. 17 is a perspective view of a reinforced shaft for a golf club, according to some embodiments of the invention;

FIG. 18 is a perspective view of a reinforced shaft for a golf club, according to some embodiments of the invention;

FIG. 19 is a perspective view of a reinforced shaft for a golf club, according to some embodiments of the invention;

FIG. 20 is a view illustrating examples of cutting shapes for pre-preg used in a reinforced shaft for a golf club, according to some embodiments of the invention;

FIG. 21 is a view illustrating a golf club with reinforced shaft according to some embodiments of the invention;

FIG. 22 is a view illustrating the golf club of FIG. 21, as instrumented during testing;

FIG. 23 is a view of golf ball impact location, showing dispersion using a steel iron shaft (left) and a reinforced shaft according to some embodiments of the invention (right);

FIG. 24 is a chart showing testing data for a golf club with reinforced shaft according to some embodiments of the invention;

FIG. 25 is a plot of trajectories using a steel iron shaft and a reinforced shaft according to some embodiments of the invention;

FIG. 26 is a view of golf ball impact location, showing dispersion using a steel iron shaft and a reinforced shaft according to some embodiments of the invention; and

FIG. 27 is a view of golf ball impact location, showing dispersion using a steel iron shaft and a reinforced shaft according to some embodiments of the invention.

### DETAILED DESCRIPTION

Modern arrows are typically made from a carbon fiber arrow shaft that is hollow, and include an arrow tip in the front of the arrow shaft, a nock in the rear of the arrow shaft, and fletching along the surface of the arrow shaft adjacent the nock. In flight, the hollow arrow shaft flexes slightly along its length in an oscillatory motion. Specifically, the action of shooting the arrow from the bow creates a deflection along the length of the arrow, which oscillates as the arrow travels. As a result, archers generally choose the arrow shaft and its components to match their equipment and to meet their shooting requirements. This includes choosing an arrow shaft having the correct length, weight, and stiffness. Archers chose an arrow shaft with a defined static spine, which is the stiffness of the arrow shaft and its resistance to bending. Based on their chosen arrow shaft and corresponding static spine, they then add tips, fletching, and knocks to tune the dynamic spine, which is the deflection of the arrow when fired from a bow. The physical properties of the arrow shaft, including the overall weight and the center of gravity of the arrow, affect the arrow's performance.

For a specific arrow shaft having a particular length and static spine, the change in weight will adversely affect the static spine of the arrow shaft. The static spine of an arrow shaft is generally determined by the material of the arrow shaft, the thickness of the arrow shaft walls, and the length of the arrow shaft. Changing weight between arrow shafts made of the same carbon fiber material with the same length requires changing the wall thickness of the arrow shaft. The thinner walled arrows shafts will be lighter, but will have a lower static spine because the stiffness of the arrow shaft would decrease. Altering any one of the properties of the arrow shaft will affect the other. This limits the ability of the archer to choose a particular carbon fiber arrow shaft having a specific weight, length, and diameter with a specific static spine.

Some arrows are constructed entirely out of aluminum or are constructed out of a hybrid aluminum and carbon composite. Arrows constructed out of a hybrid aluminum and carbon composite are generally made from an aluminum shaft and carbon that is either wrapped on the outside of the aluminum tube or molded to the inside of the aluminum tube. These arrows exhibit permanent deformation when launched and extracted from a target because of the low yield strength of aluminum. This results in a change in straightness of an arrow after repeated shooting or even after its initial shooting. The straightness of an arrow has a direct impact on the accuracy of the arrow. This creates a condition for a bent arrow that significantly reduces the accuracy of the arrow.

In some embodiments, the invention provides a lightweight, high-strength shaft with a reinforcing layer. The reinforced shaft is constructed of multiple layers. In some embodiments, two different materials are used to form the reinforced shaft: a carbon fiber material and a mesh material (e.g., comprising a metal such as stainless steel). The carbon fiber material and/or the mesh material may be provided as a “pre-preg” (i.e., pre-impregnated with a resin).

In some embodiments, the invention provides a shaft comprising a longitudinal axis, an inside diameter spanning the longitudinal axis, an outside diameter spanning the longitudinal axis, and a reinforcing layer. The shaft can be manufactured from fiber reinforced plastic, such as carbon fiber, or other materials generally known and used in the sporting goods industries. The reinforcing layer may be a mesh material. The reinforcing layer increases strength, such as hoop and compressive strength, speed, durability, and dynamic response.

In some embodiments, the invention provides a lightweight shaft having an overall stiffness comparable to the stiffness of a heavier shaft. In some embodiments, the invention provides a shaft having a smaller outer diameter. In some embodiments, the invention provides a thin walled shaft having an overall stiffness comparable to a thicker walled shaft.

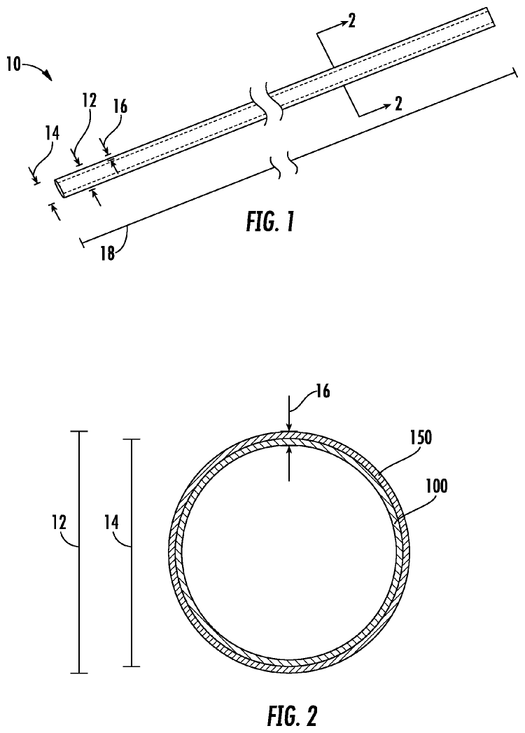

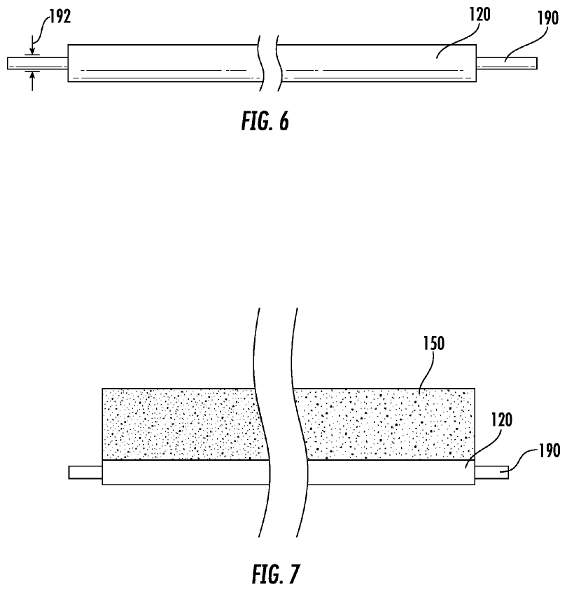

Referring initially to FIG. 1, a perspective view of an illustrative reinforced shaft according to various embodiments of the present invention is shown and generally designated 10. Reinforced shaft 10 has an outside diameter 12, an inside diameter 14, a wall thickness 16, and a length 18. The reinforced shaft 10 is constructed of multiple layers. As shown in FIG. 2, the reinforced shaft of FIG. 1 has two layers, each made of a different material. A carbon fiber material 120 (shown in FIG. 6) forms a carbon fiber blank 100, which is wrapped with a reinforcing layer 150, such as a metal mesh, for instance, a stainless steel mesh. The carbon fiber material 120 forms the first, inner layer and the reinforcing layer 150 forms the outer, second layer of the reinforced shaft 10. It is contemplated that in alternative embodiments, multiple layers may be used with multiple different materials, in multiple different combinations.

In some embodiments, the reinforcing layer 150 is a sheet of metal mesh with 80×80 wires per square inch and a wire diameter of 0.001-0.002 inches. In an illustrative embodiment, the reinforcing layer 150 is a stainless steel mesh. The pattern of the steel mesh is a plain weave where the warp wire (wire running parallel to the length of the mesh material) passes alternately over and under the wires running traversely through the mesh material (fill or shoot wires) at 90 degree angles. The reinforcing layer 150 is oriented such that the warp wire is parallel with the length of the carbon fiber blank 100 and the fill wire is perpendicular with the length of the carbon fiber blank 100, or vice versa. By orienting the mesh in this particular manner, the reinforcing layer provides additional hoop strength to the carbon fiber blank 100. It is contemplated that the angle of the mesh wires may be varied according to application and desired overall strength of the reinforced shaft 10. It is further contemplated that the number of wires per inch and wire diameter may be changed to fit the strength characteristics desired for the reinforced shaft 10. The type of metal used for the metal mesh is not meant to be limiting and the determination of type of metal used may be determined by the strength characteristics desired for the reinforced shaft 10. It is also contemplated that the reinforcing layer 150 may be made of alternative types of materials instead of, or in addition to, metal.

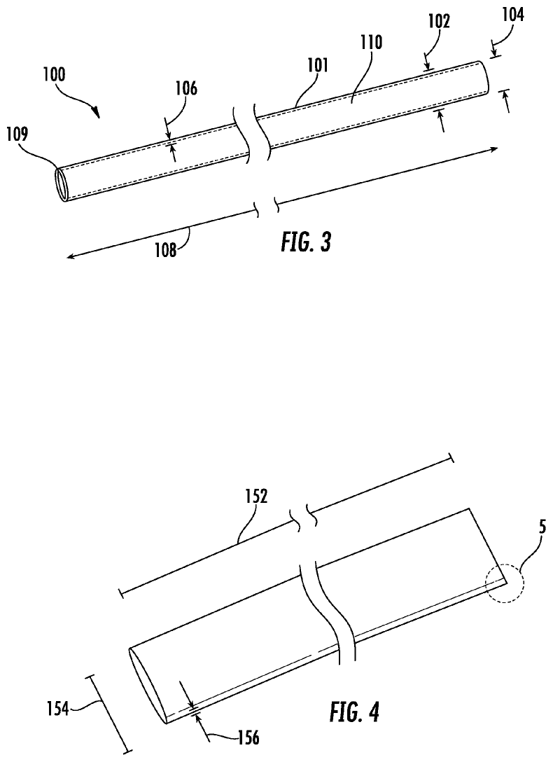

Referring now to FIG. 3, carbon fiber blank 100 consists of a cylindrical tube 101 having an outside diameter 102, an inside diameter 104, a wall thickness 106, and a length 108. The cylindrical tube 101 has an unfinished exterior 110. In certain preferred embodiments, cylindrical tube 101 is made from a carbon fiber material or a composite material composed in part of carbon fiber. However, other materials, such as wood or metal, are fully contemplated without departing from the spirit of the invention. Due to the nature of carbon fiber, exterior surface 110 of the cylindrical tube 101 is unfinished and may contain surface irregularities, which may cause the cylindrical tube 101 to exceed the dimensions required for the finished reinforced shaft 10. To prepare cylindrical tube 101 for receiving a reinforcing layer 150 (shown in FIG. 4), exterior surface 110 may optionally be ground to remove imperfections and to meet the desired physical properties, such as diameter and straightness.

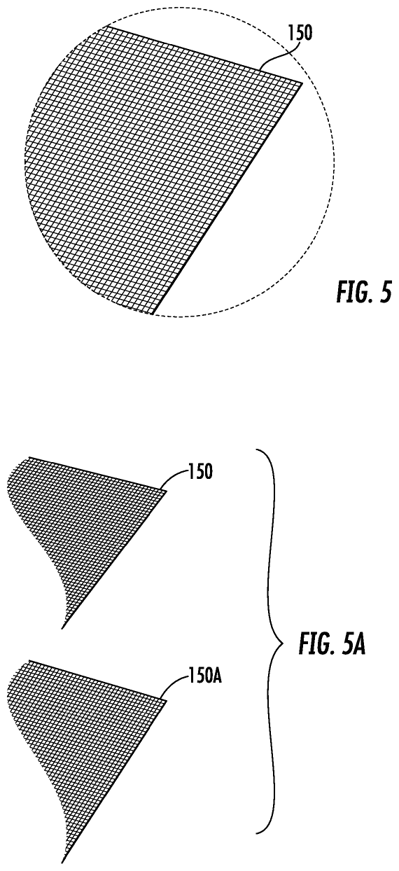

Referring now to FIG. 4, in conjunction with FIG. 5, reinforcing layer 150 is shown. In the preferred embodiment, the reinforcing layer 150 is a sheet having a length 152, width 154, and thickness 156. The length 152 of the reinforcing layer 150 is equal to or substantially equal to the length 108 of the cylindrical tube 101. The width 154 of the reinforcing layer is equal to or substantially equal to the circumference 109 of the cylindrical tube 101. In an illustrative embodiment, the reinforcing layer 150 is a sheet of stainless steel mesh with 80×80 wires per square inch and a wire diameter of 0.001-0.002 inches. The addition of the weight of the steel metal mesh in an illustrative reinforced arrow shaft is 1.2 grains/inch. The addition of the reinforcing layer 150 that is a steel metal mesh increases the strength of the shaft 10 while only adding minimal weight. Further, multiple reinforcing layers (such as 150, 150A shown in FIG. 5A) may be used, optionally with each reinforcing layer 150, 150A oriented at a different angle.

The mesh can be manufactured in any way known to a person having skill in the art. The mesh can be any type of mesh, including, but not limited to, fabric filter cloths. The mesh can be a woven or knitted mesh and can have any weave or knit known to a person having skill in the art. Non-limiting examples of such weaves include plain weave, regular weave, twill weave, flat tow weave, plain Dutch weave, and reverse Dutch weave. In some embodiments, the mesh is woven with a plain weave, Dutch weave, twilled weave, twilled Dutch weave, reverse Dutch weave, or five heddle weave.

The mesh can be made from any material known to a person having skill in the art.

Non-limiting examples of the materials that can be used for the mesh include aluminum, steel, stainless steel, brass, titanium, neodymium magnetized wire, nickel, silver, a synthetic fiber, such as nylon or poly-paraphenylene terephthalamide, or any combination or alloy thereof. A person having skill in the art would know to use any material, or a combination or alloy thereof, to achieve a desired ultimate tensile strength and/or yield strength. In some embodiments, the alloy used is nitinol.

The mesh can be modified from as low as 20 mesh to up to 500 mesh. A person having skill in the art would modify the mesh to achieve a preferred density for the arrow, golf club, rifle barrel, etc. A person having skill in the art can adjust the mesh from one end of the shaft to the other to tune the shaft. Modifying the number of wires per inch as well as varying the wire diameters in the warp and weft directions can achieve preferable results, such as faster arrow recovery, deeper penetration greater stored kinetic energy, increased structural durability, as well as changing the front of center balance of the arrow.

In some embodiments of the invention, the mesh material is a woven 304 stainless steel, with 200 mesh (0.002 inch thick wire×0.002 inch thick wire). In other embodiments, the mesh material is a Dutch weave using 0.0032 inch (0.0813 mm) thick wire×0.0018 inch (0.04572 mm) thick wire, in which the 0.0032 inch wire is in the warp direction, which runs parallel along the longitudinal length of the tube, and the 0.0018 inch wire will be the weft which will wrap around the tube.

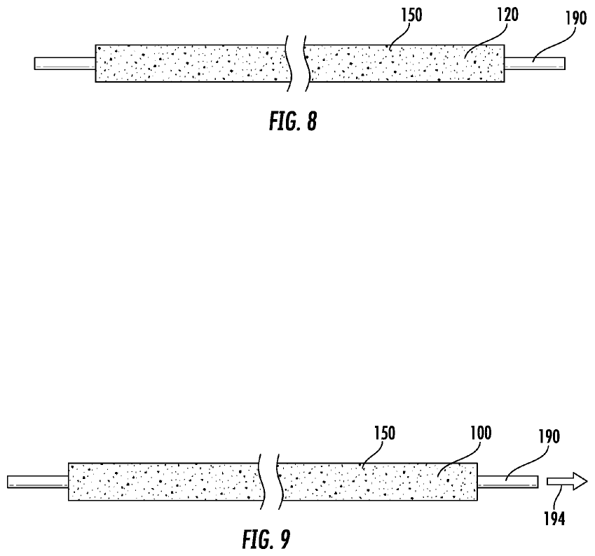

Referring now to FIGS. 6-9, an illustrative manufacturing method for a reinforced shaft 10 is shown. Carbon fiber manufacturing is known in the art, and includes the wrapping of carbon fibers around a mandrel and impregnated with epoxy which is then heated and formed into the desired article of manufacture. The shaft can be formed by rolling a first unidirectional carbon fiber around a mandrel to form a carbon fiber core. The unidirectional carbon fiber material can be cut patterns of unidirectional carbon fiber. In some embodiments, the unidirectional carbon fiber is rolled at an essentially 0 degree angle. A second unidirectional carbon fiber can be wrapped around the tubular core to form the shaft. In some embodiments, the second unidirectional carbon fiber is wrapped at an essentially 90 degree angle. In other embodiments, the second unidirectional carbon fiber is wrapped at an essentially 45 degree angle. In various embodiments, the second unidirectional carbon fiber is a woven material.

For some embodiments of the present invention, a side view of the manufacturing method shows the use of mandrel 190 with diameter 192 wrapped with carbon fiber material 120. After applying the carbon fiber material 120 around the mandrel 190, the reinforcing layer 150 is applied around the carbon fiber material 120. The diameter 192 of the mandrel 190 forms the interior diameter 14 of the reinforced shaft 10 and the amount of carbon fiber material 120 wrapped around the mandrel 190 in conjunction with the thickness of the reinforcing layer 150 forms the exterior diameter 12 of the reinforced shaft 10. After curing the carbon fiber material 120 wrapped with the reinforcing layer 150, the mandrel 190 is removed in direction 194 leaving a reinforced shaft 10 with a carbon fiber blank 100 with a reinforcing layer 150. The carbon fiber blank 100 with reinforcing layer 150 is finished into the reinforced shaft 10.

The carbon fiber material 120 can be made by molding fiber reinforced plastic, pultruding carbon fiber, or casting or extruding a metal, such as aluminum. One non-limiting type of carbon fiber is “pre-preg,” which is a carbon fiber material pre-impregnated with a resin. The carbon fiber material 120 can be formed from any material known to those of skill in that art. The carbon fiber material 120 can also be formed by shaping fiber reinforced plastic, carbon fiber, or extruding aluminum around a mandrel.

The reinforcing layer 150 can be fiber reinforced plastic, pultruding carbon fiber, or casting or extruding a metal sleeve, such as aluminum. The reinforcing layer 150 can be formed from any material known to those of skill in the art. The material used for the reinforcing layer 150 can be the same as, or different from, the material used to form the carbon fiber material 120. By way of non-limiting example, the carbon fiber material 120 can be made of a metal, such as aluminum, and the reinforcing layer 150 can be made of a fiber reinforced plastic, such as carbon fiber; the carbon fiber material 120 can be made of a fiber reinforced plastic, such as carbon fiber, and the reinforcing layer 150 can be made of a metal, such as aluminum; the carbon fiber material 120 and the reinforcing layer 150 can both be made of a fiber reinforced plastic; or the carbon fiber material 120 and the reinforcing layer 150 can both be made of a metal.

The reinforcing layer 150 can be part of the construction of the carbon fiber material 120. The reinforcing layer 150 can be part of the carbon fiber material 120 or it can be added or layered under or over the carbon fiber material 120, or in any layer or any successive layer that surrounds the carbon fiber material 120. The reinforcing layer 150 can be used on all or only a portion of the shaft. Different reinforcing layers 150 or meshes may be used in or on the shaft. Multiple reinforcing layers 150 may be oriented at the same or different angles in or on the shaft. In some embodiments, the reinforcing layer 150 is a layer that spans the longitudinal axis of the shaft. In some embodiments, the reinforcing layer 150 is part of the carbon fiber material 120 of the shaft. In some embodiments, the reinforcing layer 150 is part of the outer diameter of the shaft. In some embodiments, the reinforcing layer 150 is a layer of the shaft. In some embodiments, the reinforcing layer 150 is on an arc or other portion of the shaft. In some embodiments, the reinforcing layer 150 spans the entire shaft.

In some embodiments of the invention, a reinforced arrow shaft is made in accordance with the following steps. Pre-preg, 304 stainless steel woven mesh, and glass scrim are arranged on a mandrel so that the pre-preg layer is in contact with the mandrel and the glass scrim is the layer farthest from the mandrel. Cello wrapping is applied to outside of the glass scrim layer using a horizontal cello wrapping machine. After the cello is wrapped around the outside of the pre-preg, stainless steel mesh, and glass scrim, the combined layers are placed in an oven with the mandrel to fully cure. Once cured, the shaft is removed from the oven. The outer cello wrapping is removed and/or stripped away from the shaft. The mandrel is then removed from the inside of the shaft. The shaft is then ground to the appropriate spine and outside diameter. Only the top layer of the glass scrim material will be ground making sure that there is no contact between the grinder and the stainless steel mesh.

In some embodiments, the reinforcing layer 150 may comprise a heavier metal mesh material. In some embodiments, the heavier mesh may be, for example, 304 stainless steel wire mesh, 80 mesh×120 mesh, 0.05 mm×0.05 mm. In other embodiments, the heavier mesh may be, for example, 304 stainless steel in a 150×150 mesh using a 0.0024 inch (0.06096 mm) diameter wire. In some embodiments, the heavier metal mesh may use another type of stainless steel (such as, but not limited to, 316L stainless steel) or other metal/alloy as described above.

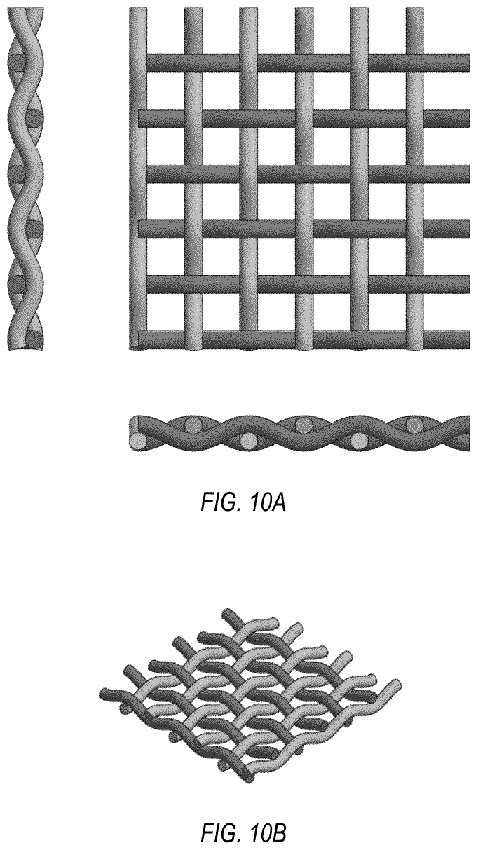

In some embodiments, the reinforcing layer 150 may comprise a feather-weight metal mesh material. The feather-weight metal mesh material may have, for example, at least 150×150 wires per square inch (150 mesh) and a wire gauge (diameter) of 0.001 inches (0.0254 mm) or less. The feather-weight metal mesh material may be made from stainless steel, such as, but not limited to, 304 stainless steel or 316L stainless steel, or other metal/alloy as described above, and can have any weave (e.g., plain weave, Dutch weave, twilled weave, twilled Dutch weave, reverse Dutch weave, five heddle weave), such as, but not limited to, a standard or Dutch weave. In some embodiments, the feather-weight metal mesh material has a standard weave, and can be oriented at different angles. FIG. 10A shows top, side, and end views of a standard/plain weave mesh, according to some embodiments. FIG. 10B shows a perspective view of standard weave mesh, according to some embodiments.

The metal mesh material (304 or 316L stainless steel or other metal/alloy) used for the reinforcing layer 150 may be non-annealed or annealed. Annealing is a heat treatment process that can make the wires in the weave softer and malleable. During this process, a roll of mesh is exposed to extremely high heat (while staying well below the melting point of the metal) and pressure. Annealing wire mesh reduces the internal stress and hardness of the weave, which can make it easier to form, for example, over an arrow or golf mandrel. In some embodiments, a reinforcing layer 150 comprising a metal mesh made from annealed stainless steel can be more malleable and easier to roll onto sporting goods shafts such as arrow shafts and golf shafts, as compared to mesh made from non-annealed metal.

In some embodiments, the reinforcing layer 150 may be provided as a “pre-preg” wherein the mesh material (e.g., woven metal mesh) is pre-impregnated with a catalyzed resin (e.g., epoxy). Similar to embodiments of the carbon fiber pre-preg described above, during the impregnation process, a fiber or woven substrate (e.g., woven metal mesh) is sandwiched between two films consisting essentially of resin. The resin films and the substrate material that is between the two films is then subjected to heat and high pressure which spreads the substrate reinforcement and forces the resin into the substrate. Once the resin has impregnated the substrate thoroughly, the carrier paper that one of the resin films is applied to is removed and the prepreg is slit to an exact width and rolled onto a final cardboard core. The pre-preg material is then cut into precise patterns and rolled onto a mandrel and cured. Once the material has been cured, the tube is extracted from the mandrel yielding a composite tubular structure.

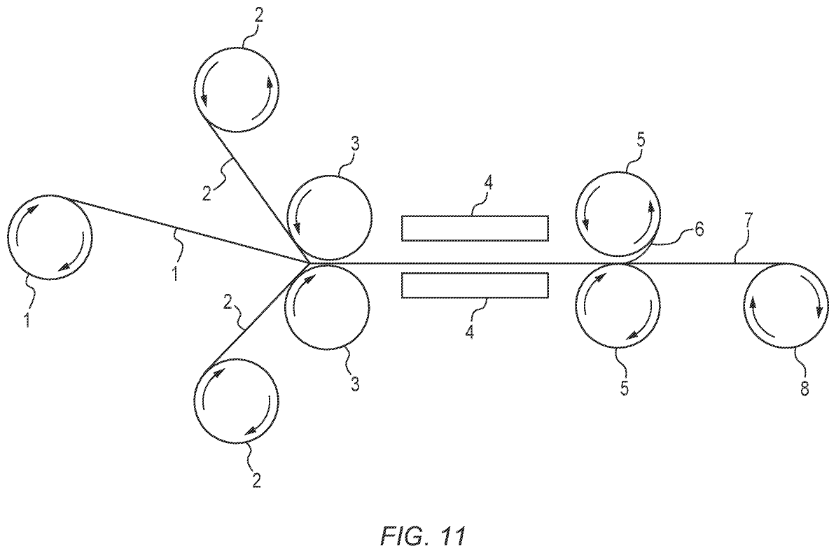

In some embodiments, the reinforcing layer 150 may comprise a pre-preg material formed as shown schematically in FIG. 11, where 1 indicates a let off roll containing the woven metal mesh material (stainless steel weave), 2 indicates rolls for paper-backed resin films that are attached to each side of the stainless steel weave as it is pulled through the machine, 3 indicates initial compaction rolls, 4 indicates a section run through a heated oven, 5 indicates a final set of rollers that the pre-preg passes through, where one of the paper carrier films 6 that the resin was cast onto is removed, and 7 indicates the final pre-preg being rolled onto a cardboard core 8.

In some embodiments of the invention, a reinforced shaft for a rifle barrel may be provided, which can overcome certain barriers in making carbon fiber rifle barrels. In existing carbon fiber rifles, shooting heats up the resin in the carbon fiber composite material, which can have deleterious effects, for example, on the barrel straightness. Metal particles (e.g., iron particles) can be added to the resin used to form the carbon fiber composite to provide a heat path; however, this addition weakens the resin substantially. In contrast, when a woven metal mesh layer according to embodiments of the present invention (e.g., reinforcing layer 150 as described above) is incorporated on a stainless steel rifle barrel, it can act as a continuous heat sink in the composite; the heat being generated and transferred into the composite is thus more uniform, which can eliminate softening of the resin and provide a more accurate rifle.

A reinforced shaft for a rifle barrel according to various embodiments of the invention may be made by a method comprising rolling at least one reinforcing layer around a steel rifle barrel, and rolling at least one carbon fiber layer around the reinforcing layer(s). In some embodiments, the reinforcing layer comprises at least one metal mesh pre-preg layer as described above in connection with reinforcing layer 150, and the carbon fiber layer comprises a carbon fiber composite material such as carbon fiber material 120. The metal mesh pre-preg reinforcing layer(s) can act as a thermal conductor of heat away from the steel portion of the rifle barrel, and can also act as a heat conductor from the chamber end directed toward the muzzle end of the rifle barrel. The metal mesh wire can provide, for example, about 15 times the thermal conductivity of a non-reinforced carbon fiber structure. In some embodiments, the metal mesh wire may comprise a metal that holds a magnetic charge (e.g., neodymium) and can provide an integral magnetic field inside the composite structure. The metal mesh wire can absorb the heat from a rifle being fired, and can reduce the amount of heat transferred to the surrounding composite material. The metal mesh wire can reduce the amount of heat in the surrounding resin system of the composite material (thus acting as a heat sink). The metal mesh wire can allow the composite rifle barrel to maintain its straightness and accuracy by reducing the softening effect on the composite when undergoing rapid firing. The metal mesh wire adds significant strength and stiffness to a rifle barrel compared to other methods of minimizing heat effects on a composite barrel, such as adding metal particles to the epoxy resin in the composite itself.

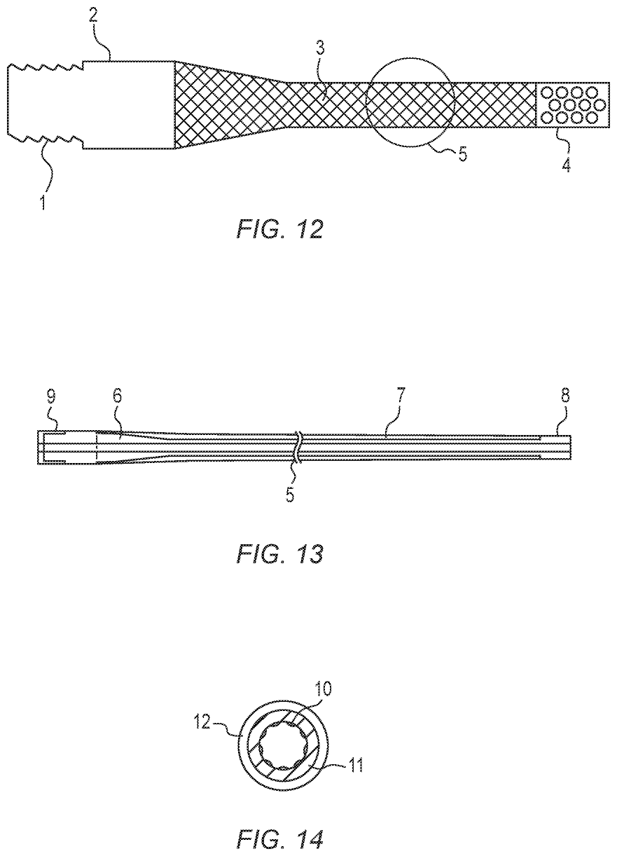

FIG. 12 shows a side view of a reinforced shaft for a rifle barrel, according to some embodiments of the invention. In FIG. 12, reference numerals indicate features of the shaft as follows: 1—threaded chamber end of the rifle barrel; 2—steel chamber end; 3—composite section with metal mesh wire embedded into structure; 4—muzzle end flash suppressor; 5—detailed cross section of steel barrel and composite (see FIG. 14).

FIG. 13 shows a cross section view of a reinforced shaft for a rifle barrel, according to some embodiments of the invention. In FIG. 13, reference numerals indicate features of the shaft as follows: 5—detailed cross section of steel barrel and composite (see FIG. 14); 6—detail of the stainless steel barrel profile; 7—composite section with metal mesh wire embedded into structure; 8—muzzle end of barrel; 9—chamber end of barrel.

FIG. 14 shows a cross section view of a reinforced shaft for a rifle barrel, according to some embodiments of the invention. In FIG. 14, reference numerals indicate features of the shaft as follows: 10—raised area showing the rifling on the inside of the steel barrel; 11—one or more layers of woven metal mesh pre-preg (or other embodiment reinforcing layer 150 described above) placed around the outer surface of the steel barrel; 12—one or more layers of carbon fiber composite material located outside the metal mesh layer(s). As described above, in some embodiments, a first carbon layer may comprise a unidirectional carbon fiber wrapped at an essentially 0 degree angle, and a second or subsequent carbon layer may comprise a unidirectional carbon fiber wrapped at an essentially 90 degree angle.

In some embodiments, as shown in FIGS. 12-14, the reinforcing layer(s) surround the entire circumference of the rifle barrel along the length of the barrel between the chamber and the muzzle. In some embodiments, the chamber and the muzzle of the barrel are not reinforced. Preferably, the reinforcing layer(s) are completely covered/insulated by the carbon fiber layer(s). In some embodiments, a glass scrim material may be optionally applied to the outermost carbon layer. The glass scrim may then be ground to finish the shaft without damaging the carbon fiber.

In some embodiments, the invention provides a reinforced shaft for a rifle barrel, comprising: at least one reinforcing layer positioned around the outer surface of a steel rifle barrel between a chamber end of the barrel and a muzzle end of the barrel, wherein the reinforcing layer comprises a woven metal mesh pre-impregnated with a resin; and at least one carbon fiber layer positioned around the reinforcing layer(s), wherein the carbon fiber layer comprises a unidirectional carbon fiber composite material. In some embodiments, the invention provides a method of manufacturing a reinforced shaft for a rifle barrel, comprising: wrapping at least one reinforcing layer around the outer surface of a steel rifle barrel between a chamber end of the barrel and a muzzle end of the barrel, wherein the reinforcing layer comprises a woven metal mesh pre-impregnated with a resin; and wrapping at least one carbon fiber layer around the reinforcing layer(s), wherein the carbon fiber layer comprises a unidirectional carbon fiber composite material. In some embodiments, the mesh comprises stainless steel. In some embodiments, the mesh comprises neodymium. In some embodiments, the mesh has a standard or Dutch weave. In some embodiments, the resin is an epoxy resin. In some embodiments, the mesh has at least 150×150 wires per square inch. In some embodiments, the mesh comprises wire having a diameter less than or equal to about 0.001 inches (0.0254 mm).

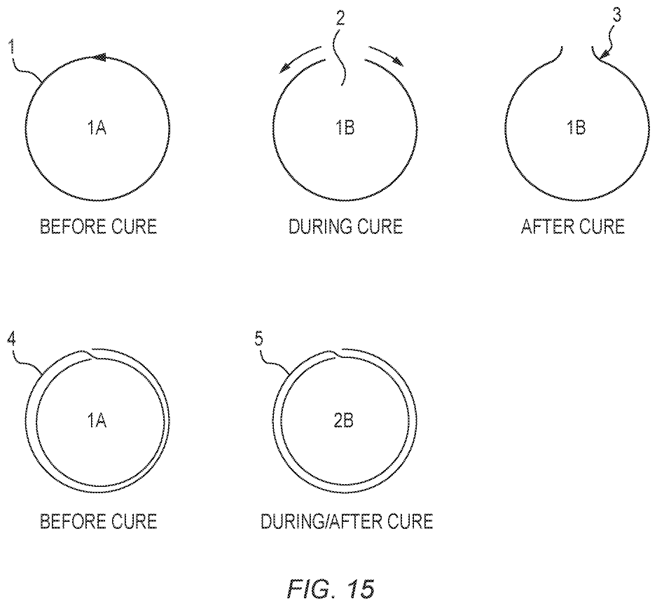

In some embodiments, the reinforcing layer 150 may comprise a minimum of two consecutive wraps of metal mesh pre-preg. For example, in some embodiments, the metal mesh weave may be prone to open up during the curing. This opening can create a structural problem in that when the material opens up during the curing of the epoxy resin it creates an opening in the weave, which can displace the surrounding material and potentially cause a structural failure. By placing a continuous double wrap of the metal mesh weave in the structure, the chance of the metal mesh opening up during curing may be reduced or eliminated. See, for example, FIG. 15, wherein 1A shows a single wrap of the metal mesh 1 before going through a cure cycle; 1B shows a single wrap of the metal mesh 2 as it is being cured (where the layer starts to open up during the cure cycle); and 1C shows a single wrap of the metal mesh 3 after it is cured (where the layer opens up and displaces the composite material that is outboard of the metal mesh). In contrast, FIG. 15 at 2A shows a double wrap of metal mesh 4 before going through a cure cycle; and 2B shows a double wrap of metal mesh 5 during/after curing. As illustrated schematically in FIG. 15, by having a minimum of two continuous wraps, the metal mesh material of the reinforcing layer 150 may be prevented from opening up and displacing the composite material (such as carbon fiber material 120) positioned around the metal mesh weave.

In some embodiments, when a reinforcing layer 150 comprising a metal mesh weave as described above is incorporated into a structure such as an arrow or a golf shaft, the dynamic response is very different than the same structures that do not have any of the metal mesh weave in them. For example, in two otherwise identical arrows, the arrow that contains the metal mesh weave will respond much faster downrange immediately after being fired out of a bow. It was previously considered that two arrows that have the same OD, ID, static stiffness and weight should respond identically from being shot from a bow. The present inventors discovered that if one of these two arrows contains a reinforcing layer 150 comprising a metal mesh weave (e.g., stainless steel weave) as described above, that the arrow recovers much faster during the launch phase of an arrow and thus is more accurate and has a higher kinetic energy by reducing the amount of energy lost during the arrow response phase after being fired.

In the case of golf shafts, one of the key attributes, and one of the major hurdles especially for shafts designed for iron head applications, has been a wide range of variability in shot consistency. This is one of the main reasons why virtually all Tour players for the most part still use steel shafts in their irons. Many factors can contribute to this variability including: flaws in manufacturing, using an anisotropic material like carbon/epoxy compared to an isotropic material like steel, and variations along the length of a composite shaft in bending stiffness. For over 30 years, graphite golf shaft manufacturers have worked diligently to overcome these inherent issues with graphite shafts to no avail.

The present inventors identified that the effect of the metal mesh weave that was observed on an arrow might be applied to a golf shaft. In the case of an arrow, one can shoot an arrow through paper targets and place these targets at different distances from where the arrow leaves the bow. It can be determined based on the ghost imprint left on the paper as the arrow travels through the paper target, the orientation and direction of the arrow as it travels downrange. This is difficult to quantify due to the speeds involved; however the present inventors have determined that arrows with a reinforcing layer 150 comprising a metal mesh weave as described above recover much faster dynamically than an arrow without the weave.

In golf shafts with stainless steel weave according to embodiments of the present invention, the weave may be used locally increase the density of the shaft in certain areas while at the same time using the mechanical properties of stainless steel to provide added stiffness and reducing torque levels compared to simply using a densified resin with tungsten powder that only provides increased density but adds nothing to the strength or stiffness to the shaft.

One of the first things noted when the stainless steel weave was incorporated into a golf shaft design was that the shafts had a different but pleasing feel to them and also the sound at impact changed, indicating that the stainless steel weave was providing some damping improvement. In some embodiments, golf shafts according to the present invention may incorporate a lighter weight stainless steel weave, such as the feather-weight metal mesh material described above. With this lighter weight mesh, a full-length ply of the stainless steel weave may be placed into a design. In some embodiments, the thicker stainless steel weave was over three times thicker and heavier than the lighter weight mesh. One of the challenges faced, however, was that unlike an arrow shaft, which can be shot through a paper target to determine the rate of recovery as described above, there was no way to accurately determine the rate of recovery of a golf shaft other than having players hit clubs with various shafts and measure ball flight characteristics using a Trackman. This technique is very useful and generates a myriad of data; however, the data for the most part is after the ball has been impacted by the club face, and thus reveals very little about the shaft dynamics. Ideally, a shaft should come back to its “neutral” or unloaded state just prior to impacting the golf ball which allows the head to square up to the ball which minimizes the loss of energy (longer distance) and also increases the downrange accuracy of the ball.

Accordingly, to determine the recovery rate for golf shafts of the present invention, inventors employed a non-contact measurement technology that has the ability to capture the motion of an object in space and at relatively high speeds. This technology is not just a simple high speed camera system, it is a network of six high speed cameras with an algorithm that can capture and quantify the movement of an object in space. This is extremely important because it is one thing to be able to see, as in the case of an arrow, if one design recovers faster than another design by stating it qualitatively. It is another thing to be able to quantify the actual recovery rate.

This non-contact technique is especially critical in golf, where a human being is swinging a golf club at a high speed through space dynamically. The only dynamic testing typically performed for golf shafts is bending stiffness measured on a frequency machine and measured in cycles per minute. However, this test is performed by having the grip end firmly held in one position while a load is being applied, whereas in the actual swinging of a golf club, nothing is held in such a position. The club itself is moving through space attached to a golfer's hands and a head is attached to the other end, which is three-dimensional in shape and has variations in how the head mass is distributed. Therefore, up until now there has been no capability to perform dynamic testing with a golf club and obtain actual data on how the golf shaft is responding during a swing. Now, the present inventors have confirmed that the static tests that have been relied upon for the last 40 years can be augmented by using this non-contact testing capability; coupling these two testing technologies together, it is possible to identify differences between static shaft properties and dynamic shaft properties.

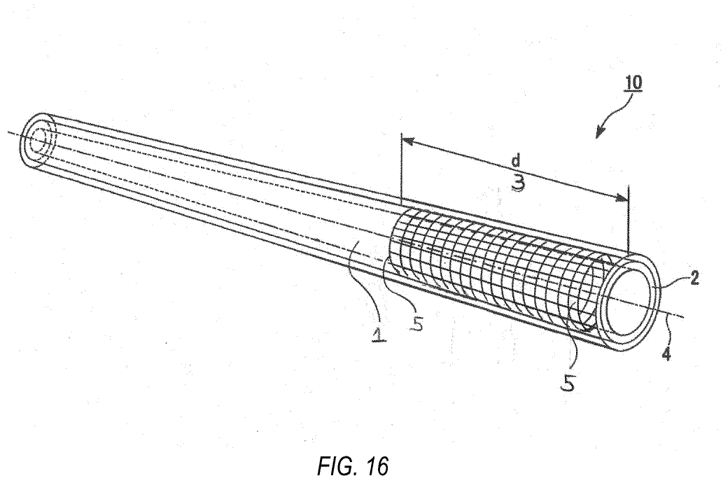

FIG. 16 is a perspective oblique view schematically illustrating an example of an embodiment of a shaft 10 for a golf club according to the present invention. This drawing illustrates that the placement of the metal mesh weave is located toward the grip end of the golf club.

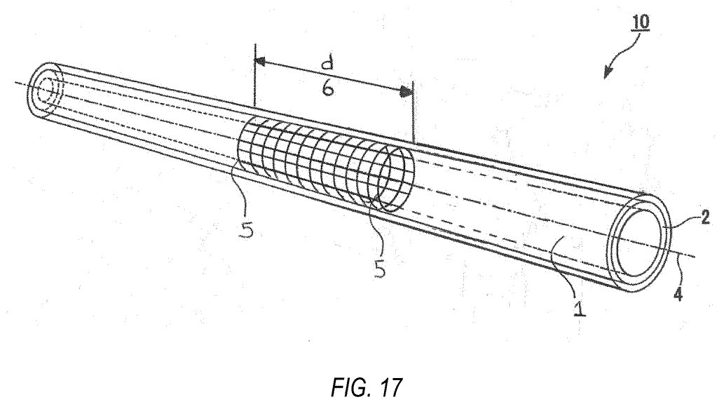

FIG. 17 is a perspective oblique view schematically illustrating another example of an embodiment of a shaft 10 for a golf club according to the present invention. This drawing illustrates that the placement of the metal mesh weave is located in the middle section of the golf club.

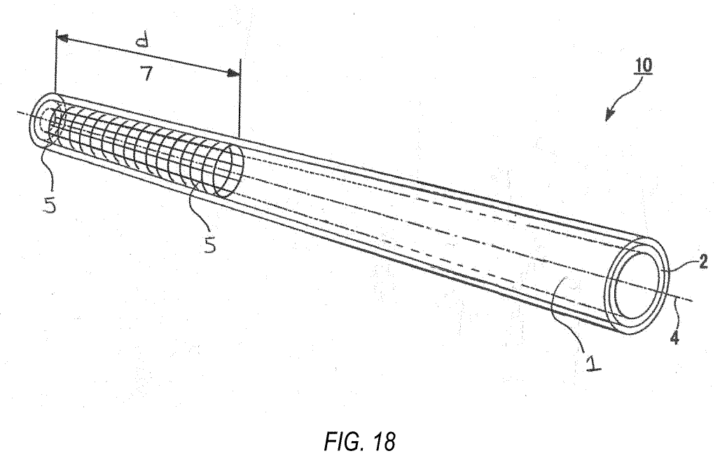

FIG. 18 is a perspective oblique view schematically illustrating an example of another embodiment of a shaft 10 for a golf club according to the present invention. This drawing illustrates that the placement of the metal mesh weave is located in the tip section of the golf club.

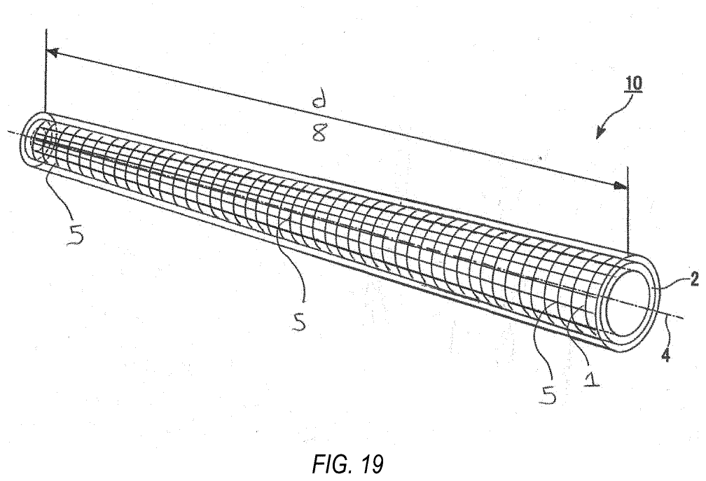

FIG. 19 is a perspective oblique view schematically illustrating an example of an embodiment of a shaft 10 for a golf club according to the present invention. This drawing illustrates that the placement of the metal mesh weave is located throughout the entire length of the golf club.

Referring to FIGS. 16-19, these drawings show various possible locations of a non-isotropic metallic weave 5 within an exemplary golf shaft 10 comprising a plurality of layers 1 and having a larger-diameter end 2 and an axis 4. Metal mesh weave 5 as shown in FIGS. 16-19 comprises a reinforcing layer 150 as described above.

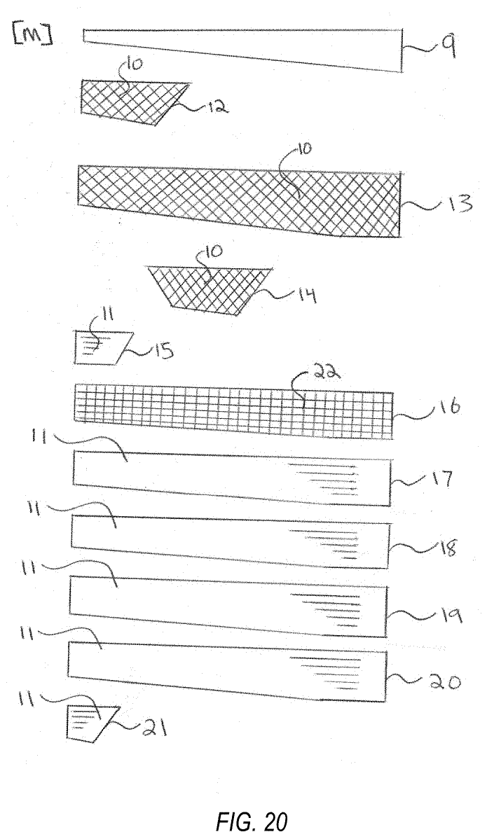

FIG. 16 depicts locating the metal mesh weave 5 in the butt section (grip) of the golf shaft which can extend from the large end of the golf shaft down to a distance that does not exceed one-third (d3) of the entire length of the golf shaft. This region of a golf shaft, whether the shaft is steel or composite, tends to be thin walled compared to the tip of the golf shaft where the loads are much higher due to the impact event of hitting the golf ball. The metallic weave placed in this region reduces the amount of crush deformation associated with a thin-walled tube undergoing bending loads. In essence, the 0/90 nature of the woven metal mesh weave 5 provides not only axial stiffness (Ei), but also significant hoop strength and hoop stiffness. Another added benefit by placing the metal mesh weave 5 in this section of the golf shaft, is that due to the increased density of metallic materials compared to the lightweight nature of carbon composites, the swing weight of the shaft itself can be affected. By using a woven fabric material, these materials can be easily added to a typical golf shaft pattern (FIG. 20).

Turning to FIGS. 17 and 18, in other embodiments, the metal mesh weave 5 can be placed in either the middle section of the shaft or at the tip end of the shaft depending on the particular shaft design or desired performance property. In some embodiments, due to the heavier nature of the metal mesh weave 5, only a certain amount of the metal mesh 5 can be used based upon the total weight of the shaft. For example, in an ultralight wood design under 35 grams in weight, one would be somewhat limited to have the metal mesh weave 5 extend over the entire length of the shaft because the metal mesh 5 would add too much weight. In this case, as shown in FIG. 18, the metal mesh 5 could be placed in the tip section, not exceeding one third (d7) of the overall shaft length, for example, to achieve a low balance point along with increasing the response rate of the tip section during the swing. The tip stiffness has a large effect on the loft angle at impact, which dictates the dynamic launch angle of the face and thus ball flight. As shown in FIG. 17, in other embodiments the metal mesh 5 may be placed in the mid-section (d6) of the shaft, which would not only stiffen this section but depending on where exactly the metal mesh 5 is placed, could add weight to the overall shaft but have very little effect on the swing weight or balance point of the shaft.

In some embodiments, as shown in FIG. 19, the metal mesh weave 5 extends in a continuous fashion over substantially the entire longitudinal length of the golf shaft. The orientation is the same as in FIGS. 16-18 in that it consists of a 0/90 orientation with the 0 degree direction being on the longitudinal axis 4 and the 90-degree direction which is transverse to the axial direction (commonly referred to as the hoop direction). In some embodiments, by extending the metal mesh weave 5 over the entire length of the shaft, the fastest, most consistent response rate of the shaft dynamically was observed. During the downswing of a golf club, the club head face is changing its reference orientation to the golf ball during the entire downswing. The golfer needs to bring the face of the clubhead around so that when the head impacts the ball it is in the same location every time. Many variables can have an effect on this process, including shaft length, swing tempo, swing style, stiffness of the shaft, among many other variables. One of the most important factors in a golf shaft, is to have the shaft consistently respond the same way regardless of swing speed and the other variables mentioned above. Having the shaft respond dynamically the same way regardless of some of these player-induced and shaft-induced irregularities is a desire of all golfers regardless of their playing ability. Another important factor, is the duration in which the club face can maintain its relative squareness during the critical ball impact event. In other words, if the face of the club can maintain a consistent orientation to the ball over a longer span, it makes the club more forgiving to the golfer in the event that their timing is off at the moment of impact. This is exactly why it is important for the shaft to quickly return to its natural state (unloaded) as quickly as possible during the swing and before impacting the golf ball.

FIG. 20 is a pattern diagram showing one of the optional locations of the metal mesh weave 5, according to certain preferred embodiments. This pattern begins with a metal mandrel 9 with a profile shape that is dependent on many factors. The actual dimensions of the mandrel 9 may vary; FIG. 20 is simply a schematic illustrating one of the possible manufacturing techniques to build a composite golf shaft. As in most composite golf shafts, the first plies (12, 13, 14) are all plies that are oriented at a +/−45-degree fiber angle (indicated by the numeral 10) which is the optimum fiber angle for controlling the torque (j value) of the golf shaft. The materials used in these plies can range from standard modulus carbon fiber up to high modulus carbon fiber, including pitch-based carbon fibers that are ultra-high modulus. Typically, these plies are unidirectional prepreg tape similar to materials used in composite arrow construction. As is common with many composite golf shaft construction techniques, the shaft construction consists of shorter plies (15, 21) to be used for increasing attributes like tip strength, tip stiffness and adding to the outer dimension of the shaft. These plies shown in the FIG. 20 diagram are oriented in an axial direction (indicated by the numeral 11), but are not limited to that orientation. Ply 16 is a layer that consists of a full-length ply of the metal mesh weave 5 which is oriented at a 0/90 orientation (indicated by the numeral 22) and runs the entire length of the shaft. This reinforcing layer as shown has at least one circumferential wrap, but is not limited to one wrap, and various embodiments may comprise two or more consecutive wraps as described above. One can utilize multiple concentric wraps of the metal mesh weave in a structure depending on overall weight constraints and loading conditions. As shown in FIG. 20, the ply 16 comprising the metal mesh weave 5 is sandwiched in between other plies in the structure; however, in some embodiments, metal mesh weave 5 may be best utilized outboard of the torque core plies (12, 13, 14) and below the full length outer axial plies (17, 18, 19, 20).

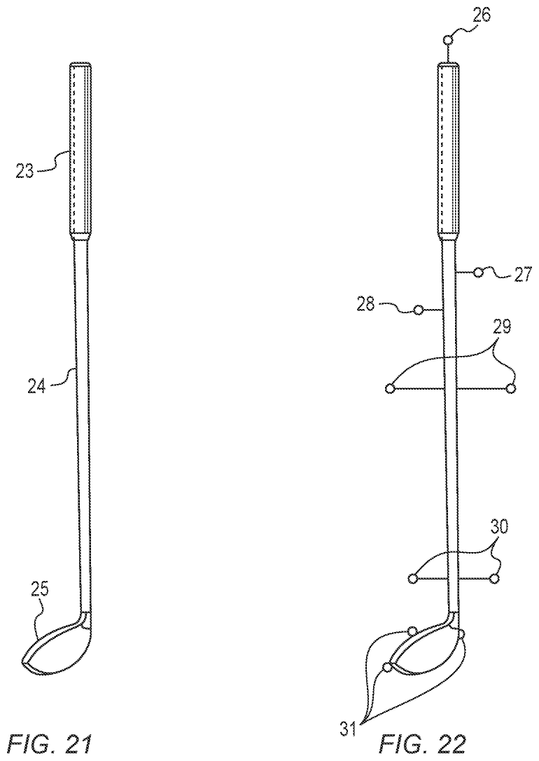

FIG. 21 shows one example of a golf club that may be reinforced with a metal mesh as described herein, which consists generally of a grip 23, a shaft 24, and a head 25. This illustration is that of a typical driver club for the purposes of simplicity; however, a reinforcing layer according to embodiments of the present invention may be applied to all types of golf clubs, and is not limited to a specific type of club (e.g., driver, iron, putter, etc.). Although the shaft designs would most likely be different, for example, for a driver as compared to an iron or a putter, the use of the metal mesh weave 5 according to embodiments of the present invention still has the same desirable effect in each, in that the metal mesh weave 5 can help the shaft recover faster back to its natural unloaded state before the club is being swung.

In some embodiments, methods of manufacture according to the present invention include methods to measure/test the response rate and moment of impact of the club during the swing and at the moment of impact with the golf ball. FIG. 22 is an illustration of the same club as in FIG. 21; however, this illustration shows how reflective markers were placed on the golf club in order to capture the movement of the club in space. As noted above, previously virtually all of the dynamic golf ball flight data was being generated by the use of Trackman. Trackman has the ability to measure the dynamic response when a golf ball is struck by a golf club. It measures data like spin rates, launch angle, ball carry, ball dispersion, etc. The data generated by this technology has been used by virtually every golf club and golf shaft manufacturer worldwide. A key deficiency in using this technology, however, is that all the data is generated after the ball has been struck. It does not tell the user what is happening with the club itself during the swing. Accordingly, methods according to the present invention employ non-contact measurement for a golf club. FIG. 22 shows a standard golf club that has a number of reflective balls (26, 27, 28, 29, 30, 31) attached to the club. These balls are made of very lightweight foam and have a unique reflective paint on them. The reflective balls are captured by six high speed cameras oriented 360 degrees around the golfer. Therefore, when the golfer swings the club the movement of the club is captured in space, resulting in a quantifiable flight path. The location of these balls is very important to be able to capture exactly what the club and the shaft are doing during the swing. Take for instance balls 29 and 30. Notice that the balls 29 are separated from the shaft but are equal distance from the centerline 26 of the shaft or the neutral axis. Balls 30 are arranged the same way except these balls are located much closer to the head in order to determine exactly how the tip stiffness is affecting the ball flight. Other balls that are placed on the shaft at locations 27 and 28 provide additional points of bending. Down at the head of the club, a minimum of three balls 31 are located on the head of the club itself. This allows a user to see the location of the head at impact of the ball. The user can determine not only where the club face struck the ball, but can also tell if the face of the clubhead is opened or closed at the point before, during and after impact. One other key feature that can be obtained from the balls 31 located on the head itself, is the dynamic loft and lie angle of the head at impact. More importantly, the algorithms utilized with this technology can provide quantitative data regarding the club and the shaft in a truly dynamic environment. Thus, using methods according to the present invention one can quantify the response rate of the shaft in both bending and torsion during the actual swing. The additive weight of these balls was under one gram of mass and therefore had little or no effect of the club's performance.

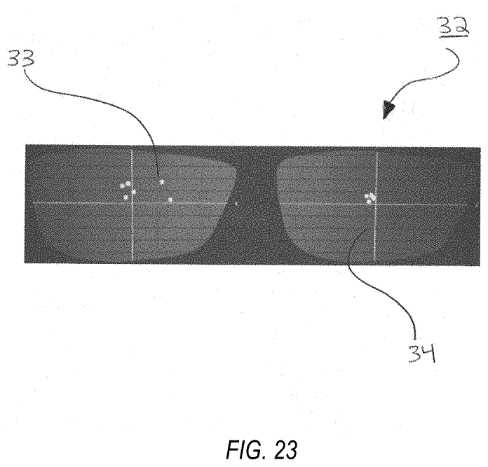

The reinforced shaft embodiment of FIG. 19 was tested in accordance with the details listed pertaining to FIG. 22. FIG. 23 shows a graphical representation (generally indicated as numeral 32) of ball strikes on a club face using the non-contact measurement techniques described above. FIG. 23 shows a generic club face for the purposes of these tests. The dots on each face profile show where the club struck the ball on the face. FIG. 23 at numeral 33 shows results for one of the more popular steel shafts on Tour coupled with one of the most popular iron heads on the Tour as well. The shaft and head weights, along with shaft lengths, were identical for both 33 and 34 clubs. The shaft at numeral 34 is the embodiment of FIG. 19, which contains a full-length layer of metal mesh weave 5. The face plots of ball strikes are a clear indication that that the shaft containing the metal mesh weave 5 had a much tighter dispersion of where the club impacted the ball versus the steel shaft. Data captured before ball impact and shortly after the ball was struck indicated that the shaft was not only squared at impact, but also before impact, which provides a much more forgiving window to actually square the club face to the ball. This data set was confirmed through the use of a mechanical robot and human player testers that are active on all the Major Golf Tours. In fact, over 12 PGA Tour Professionals tested these clubs with virtually the same results. Clubs 33 and 34 were identical statically. They weighed the same, had the same swing weight, etc., but yielded different results. This test was also performed with a placebo (all composite shaft without the metal mesh weave 5) and it performed similar to the steel shaft.

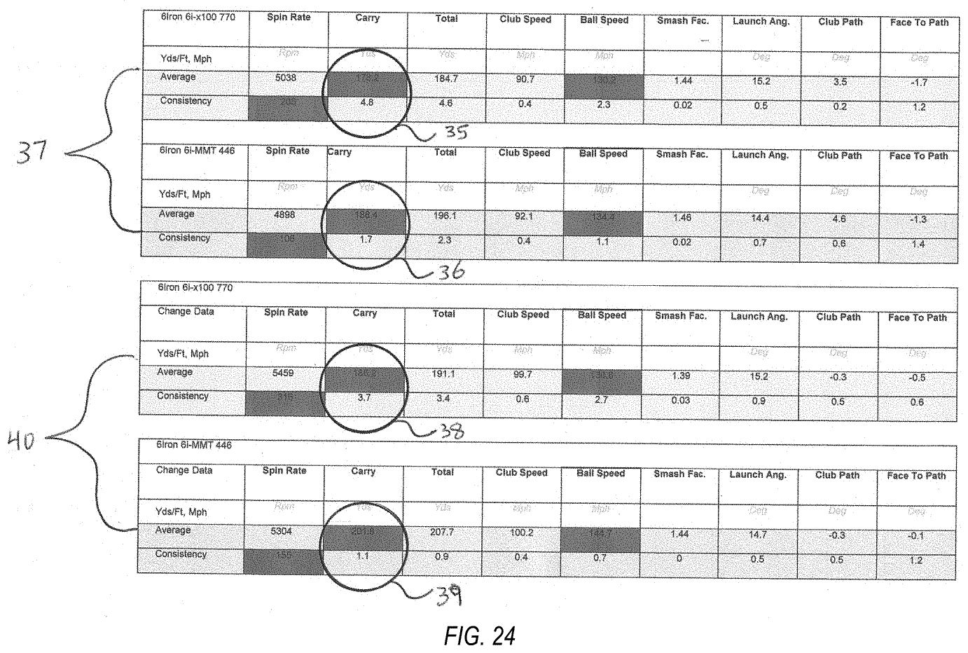

FIG. 24 shows the actual data captured during the testing event detailed in FIG. 23. Data sets 37 and 40 represent two different golfers out of the 12 golfers used for testing. Both data sets include the Trackman performance data with the upper section in each data set being those of the steel shaft used as the baseline and the composite shaft containing the metal mesh weave 5. Although there are many test parameters detailed in these data sets, what is particularly important are the Ball Carry results. For Player 37, as shown at numeral 35, he/she achieved 178.2 yards of carry with a standard deviation of 4.8 yards hitting a steel shaft. This means on average, this player can expect to see a range with his/her 6 iron being between 173 yards and 183 yards. As shown at numeral 36, the same player swinging at roughly the same swing speed, generated a carry distance of 188.4 yards with a standard deviation of only 1.7 yards hitting a composite shaft with the metal mesh weave 5 according to embodiments of the present invention. This virtually added 10 yards in carry distance with under half of the variation. For Player 40, as shown at numeral 38, this player achieved a carry of 186.2 yards with a standard deviation of 3.7 yards hitting a steel shaft. The increase carry for this golfer compared to golfer 37 was due to the players increase in swing speed from 90.7 mph up to 99.7 mph. This same golfer achieved a carry of 201.8 yards with a standard deviation of 1.1 yards hitting the same composite shaft with metal mesh weave 5 according to embodiments of the present invention The measured swing speeds of golfer 40 were virtually the same for both the steel shaft and the composite shaft with metal mesh weave 5, yet the composite shaft with metal mesh weave 5 had 12 yards of additional carry. The standard deviation on this test was 75% less than the standard deviation associated with the steel shaft.

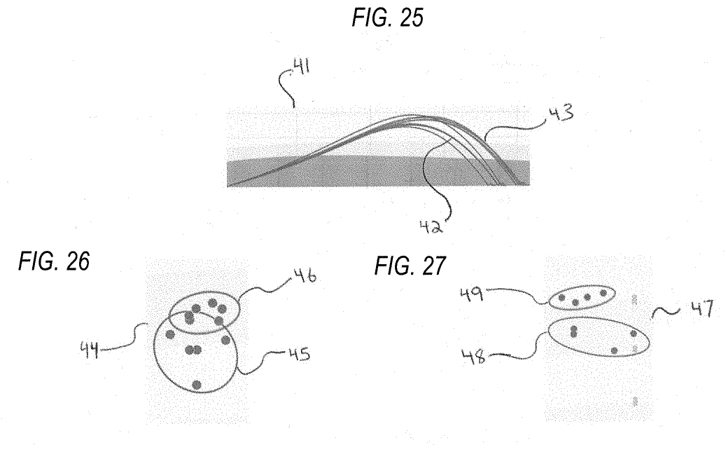

FIG. 25 is a graphical plot (generally indicated as numeral 41) of the ball flight associated with players 37 and 40 contained in FIG. 24. The trajectory indicated at numeral 42 represents the data generated by player 40 and is that of the steel shaft. The trajectory indicated at numeral 43 represents the same player 40 hitting the composite shaft containing the metal mesh weave 5. FIG. 25 shows that the composite shaft containing the metal mesh weave 5 is not only longer but has a much tighter dispersion than the steel shaft. The extra yardage and the reduced dispersion are a clear indicator that the composite shaft with the containing the metal mesh weave 5 according to embodiments of the present invention is more efficient at transferring energy resulting in increased ball flight. At the same time, by reducing the area where the club strikes the ball on the face, the dispersion is dramatically reduced also. This is due to the shaft recovering faster and maintaining its squareness to the ball before and at the point of impact than a shaft without the metal mesh weave 5.

FIGS. 11 and 12 show the ball dispersion plots (generally indicated as 44 and 47, respectively) of both players in FIG. 24. The plot at numeral 45 is that of the steel shaft hit by player 37 and the plot at numeral 46 is the dispersion plot of the same player hitting the composite shaft with the metal mesh weave 5. The plot at numeral 48 is that of the steel shaft hit by player 40 and the plot in 49 is the dispersion plot of the same player hitting the composite shaft with the metal mesh weave 5. As shown FIGS. 25-27, the composite shaft with the metal mesh weave 5 had substantially more distance and much tighter groupings than the steel shafts.

In some embodiments, the invention provides hollow golf club shaft comprising a plurality of layers which contain one or more non-isotropic layer(s) of a metallic woven reinforcement oriented within the length of the golf club shaft.

In some embodiments, the layer(s) of the metallic woven reinforcement comprise one or more of the following metals: stainless steel, nickel, titanium, copper, aluminum, magnesium, and hybrid alloys made of such metals.

In some embodiments, the non-isotropic metallic woven fabric can be placed in different locations within the hollow shaft structure to achieve desired performance properties such as balance point, stiffness, torque, etc.

In some embodiments, the metallic woven material extends in a continuous fashion over the full length of the golf shaft.

In some embodiments, the fiber orientation of the non-isotropic metallic weave is at a zero- and ninety-degree fiber orientation, where the zero-degree metallic filaments are in line with the axial (longitudinal) direction of the golf shaft and the ninety-degree orientation is perpendicular to the axial direction (hoop).

In some embodiments, the thickness of said metallic weave is within a range of 0.001″ to 0.008″ in ply thickness.

In some embodiments, the non-isotropic metallic weave is impregnated with an epoxy or thermoplastic resin which is then placed within the surrounding layers of the other non-isotropic composite materials comprising at least one of the following reinforcement materials: carbon fiber, graphite fibers, fiberglass fibers, other metallic fibers, PBO fibers, aramid fibers, aromatic polyester fibers, and carbon nanotubes.

In some embodiments, placing full length ply(s) of said metallic weave increases the recovery rate of the golf shaft during the downswing of the golf club providing a longer more consistent range of club face orientation in reference to the golf ball before impact.

In some embodiments, the addition of a non-isotropic metallic weave reduces the ball strike impact area on the face of the club resulting in an increase in accuracy and distance due to the energy and accuracy lost by having a wide range of impact locations on the club face associated with steel and composite golf shafts.

In some embodiments, placing sub full length ply(s) of said metallic weave in different areas of the golf shaft, reduces tube deformation and increases the density in such areas where the metallic weave is placed.

In some embodiments, utilizing a metallic weave versus a metallic filament or an isotropic densified filler material like tungsten powder, the metallic weave provides for a significant increase in strength due to the nature of the woven continuous fiber filaments contained in the weave. This provides not only an increase in density where the weave is located, but also adds significant strength and enables the shaft to recover faster during the swing.

While there have been shown and described fundamental novel features of the invention as applied to the preferred and illustrative embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. For example, various features and structures of the different embodiments discussed herein may be combined and interchanged. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

What is claimed is:

1. A hollow golf club shaft, comprising:
a plurality of fiber-reinforced resin layers; and
one or more reinforcing layers comprising a woven metal mesh, each reinforcing layer spanning a circumference of the golf club shaft,
wherein the woven metal mesh comprises stainless steel, nickel, titanium, copper, aluminum, magnesium, or an alloy thereof, and
wherein the woven metal mesh has at least 150×150 wires per square inch.

2. The shaft of claim 1, wherein the reinforcing layer(s) are located in the butt section of the golf club shaft, the mid section of the golf club shaft, or the tip section of the golf club shaft.

3. The shaft of claim 1, wherein the reinforcing layer(s) extend along the full length of the golf shaft.

4. The shaft of claim 1, wherein the woven metal mesh is positioned on the golf club shaft at a zero- and ninety-degree wire orientation, where the zero-degree wires are in line with a longitudinal axis of the golf shaft, and the ninety-degree wires are oriented perpendicular thereto.

5. The shaft of claim 1, wherein the woven metal mesh comprises wire having a diameter of about 0.001 inches to about 0.008 inches.

6. The shaft of claim 1, wherein the woven metal mesh comprises wire having a diameter less than or equal to 0.001 inches.

7. The shaft of claim 1, wherein the woven metal mesh has a plain weave, Dutch weave, twilled weave, twilled Dutch weave, reverse Dutch weave, or five heddle weave.

8. The shaft of claim 1, wherein the woven metal mesh is impregnated with a resin.

9. The shaft of claim 1, wherein the woven metal mesh is annealed.

10. The shaft of claim 1, wherein at least one of the plurality of fiber-reinforced resin layers comprises a carbon fiber.

11. A method of manufacturing a reinforced shaft for a golf club, comprising:
wrapping a plurality of fiber-reinforced resin layers around a mandrel; and
wrapping one or more reinforcing layers around at least one of the plurality of fiber-reinforced resin layers,
wherein the reinforcing layer(s) comprise a woven metal mesh and span a circumference of the golf club shaft,
wherein the woven metal mesh comprises stainless steel, nickel, titanium, copper, aluminum, magnesium, or an alloy thereof, and
wherein the woven metal mesh has at least 150×150 wires per square inch.

12. The method of claim 11, wherein the reinforcing layer(s) are located in the butt section of the golf club shaft, the mid section of the golf club shaft, or the tip section of the golf club shaft.

13. The method of claim 11, wherein the reinforcing layer(s) extend along the full length of the golf shaft.

14. The method of claim 11, wherein the woven metal mesh is positioned on the golf club shaft at a zero- and ninety-degree wire orientation, where the zero-degree wires are in line with a longitudinal axis of the golf shaft, and the ninety-degree wires are oriented perpendicular thereto.

15. The method of claim 11, wherein the woven metal mesh comprises wire having a diameter of about 0.001 inches to about 0.008 inches.

16. The method of claim 11, wherein the woven metal mesh comprises wire having a diameter less than or equal to 0.001 inches.

17. The method of claim 11, wherein the woven metal mesh has a plain weave, Dutch weave, twilled weave, twilled Dutch weave, reverse Dutch weave, or five heddle weave.

18. The method of claim 11, wherein the woven metal mesh is impregnated with a resin.

19. The method of claim 11, wherein the woven metal mesh is annealed.

20. The method of claim 11, wherein at least one of the plurality of fiber-reinforced resin layers comprises a carbon fiber.
